(19) United States
(12) Patent Application Publication
(10) Pub. No.: US 2012/0186136 A1
(43) Pub. Date: Jul. 26, 2012

(54) METHOD FOR REDUCING THE ABILITY OF INSECTS TO ADHERE TO SURFACES

(75) Inventors: Rodney G. Schneidmiller, Greenacres, WA (US); Qing-He Zhang, Spokane Valley, WA (US)

(73) Assignee: STERLING INTERNATIONAL INC., Spokane, WA (US)

(21) Appl. No.: 13/343,162

(22) Filed: Jan. 4, 2012

Related U.S. Application Data
(63) Continuation-in-part of application No. 13/331,394, filed on Dec. 20, 2011.
(60) Provisional application No. 61/453,033, filed on Mar. 15, 2011.
(60) Provisional application No. 61/435,647, filed on Jan. 24, 2011.

(51) Int. Cl. A01M 1/10

(52) U.S. Cl. 43/107

(57) ABSTRACT

A method for rendering a surface nonadhesive to insects is described. The method may include providing a surface, wherein the surface is desired to be nonadhesive to an insect having a foot contact structure, and creating or otherwise applying to or on the surface, features that are commensurate in size to a contact area size of the contact structure on the bottom of insect feet. The method may be used to provide a device which attaches to an insect trap cone, funnel, or pyramid, wherein the device comprises the nonadhesive surface.

### CROSS-REFERENCES TO RELATED APPLICATIONS

This application claims the benefit of U.S. Provisional Application No. 61/453,033, filed on Mar. 15, 2011, and U.S. Provisional Application No. 61,435,647, filed on Jan. 24, 2011. This application is a continuation-in-part of U.S. application Ser. No. 13/331,394, filed on Dec. 20, 2011, which claims the benefit of U.S. Provisional Application No. 61/435,647, filed on Jan. 24, 2011. All applications are incorporated herein by reference in their entirety.

### BACKGROUND

Pentatomoiidae is a superfamily of insects that includes some of the stink bugs and shield bugs. The name stink bug derives from their tendency to eject an odiferous defensive substance when disturbed, typically as a form of anti-predator adaptation. The term “stink bug” is also applied to distantly related species such as Boisea trivittata (Say), the “boxelder bug,” and insects such as beetles in the genus Eleodes (“pinacate beetles”). Many stink bugs and shield bugs are considered agricultural pest insects. They can generate large populations that damage crop production, and are resistant to many pesticides. Moreover, they are immune to the genetically modified (GM) crops, such as the Bacillus thuringiensis (Bt) crops. Over the past 5-10 years, the stink bugs and plant bugs have become serious pest problems in many parts of the world, especially in the regions with large areas of Bt crops.

For example, the brown marmorated stink bug (BMSB), Halyomorpha halys (Stal), native to Asia, is believed to have been accidentally introduced into the United States as early as 1996, likely as stowaways, possibly as eggs, on packing crates or the like. The BMSB has been recorded in a total of 33 states and the District of Columbia, according to information provided by the U.S. Department of Agriculture and the National Agricultural Pest Information System (NAPIS) (http://pests.ceris.purdue.edu). In 2010, the BMSB emerged as a severe pest of fruit and other crops across the region. In addition, this invasive species is a serious nuisance for homeowners and businesses as it over-winters in residential houses, commercial buildings, and warehouses.

The brown marmorated stink bug can cause widespread damage to fruits, vegetables and field crops, including peaches, apples, green beans, soybeans, corns, cherries, raspberries, and pears. It is a sucking insect that uses its proboscis to pierce the host plant in order to feed. This feeding may cause necrotic areas on the outer surface of fruits, leaf stippling, cat-facing on tree fruits, seed loss, and transmission of plant pathogens. Frequently, the brown marmorated stink bug survives the winter as an adult by entering structures that shield them from the elements. During the overwintering period, stink bugs are generally less active and normally aggregate in dark spaces for hibernation; however, some of stink bugs may awaken and crawl/walk around in rooms or other indoor spaces when indoor temperatures are high, especially during late winter and early spring. Such indoor activity creates various inconvenient issues (such as unpleasant smells and other annoying activities) for inhabitants. Pheromone or attractant-baited traps offer a convenient and powerful means to detect and monitor the stink bug populations and may also have a great potential for population suppressions via mass-trapping.

Disclosed herein is a useful non-stick feature for insect traps and any other device to significantly improve trap performance by reducing escape rates of the captured insects from the traps.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The embodiments of the invention disclosed in the summary section and elsewhere, relate to surface features of certain sizes designed to reduce or lessen the adhesion of insects to surfaces. As used herein, the term “nonadhesive surface” is used to describe such surfaces. The surface features can be provided on any device, machine, material, and substrate. The surface features can be created through a multiplicity of ways (as separated structures/parts or parts of the trap entrance structures), and the surface features can be of any shape or form. The surface features can be created by materials different than the underlying substrate on which the surface features are provided. Alternatively, the surface features can be created or otherwise formed from the underlying substrate. The underlying substrate may also include such surface features. The particular surfaces disclosed herein are effective to deter insects of any kind from adhering. Insects to which these surfaces can be targeted include any insect species of any order of the insect class.

In a first embodiment, a method for reducing the ability of insects to adhere to a surface is disclosed. The method includes providing a substrate, wherein a side of the substrate is covered with surface features, and wherein an average size of the surface features is commensurate in size to a size of an insect foot contact structure, and when insects walk or land on the substrate covered with the surface features, reducing the forces that bind the insect contact structures to the surface features by reducing the contact area between the insect contact structures and the surface features.

In the method of the first embodiment, the average size of the surface features can be from 0.1 to 3.0 microns and the size of the insect contact structures is from 0.1 to 3.0 microns.

In the method of the first embodiment, the insect foot contact structure can include a plurality of setae and the surface features are commensurate in size to a diameter or lateral width of a seta.

In the method of the first embodiment, the insect foot contact structure can include a plurality of spatulae and the surface features are commensurate in size to a diameter or lateral width of a spatula.

In the method of the first embodiment, the substrate can be coated with a layer comprised of particles (with their average diameter sizes range from 0.1 to 3.0 microns).

In the method of the first embodiment, the particles can be bonded to the substrate.

In the method of the first embodiment, the particles can be retained on the substrate, such that the particles are released when stepped on by insects.

In the method of the first embodiment, the substrate can be coated with polytetrafluoroethylene particles.

In the method of the first embodiment, the method may further include placing a porous film comprising the surface features over the substrate. In one embodiment, the porous film may have pore sizes of in the range from 0.1-3 μm, and the films may have a porosity (void fraction) of 20-50% of the total area of the surface.

In the method of the first embodiment, the insect can be a stink bug. However, in other embodiments, the insect can be any arthropod and/or any flying/crawling insect.

In the method of the first embodiment, the substrate can be arranged to be at an incline from horizontal, vertical, hemispherical, or horizontal facing toward the ground.

In the method of the first embodiment, the nonadhesive surface can be placed inside of a trap and juxtaposed in proximity to an opening leading into the trap, and the surface prevents insects from leaving the trap once inside the trap.

In the method of the first embodiment, a trap may include a chamber, one of a cone, funnel or pyramid, with an opening leading to an interior of the chamber, and the nonadhesive surface is juxtaposed in proximity to the opening on the inside of the chamber.

In the method of the first embodiment, a trap may include a chamber, one of a cone, funnel, or pyramid, with an opening leading to an interior of the chamber, and the cone, funnel, or pyramid comprises the nonadhesive surface.

In a second embodiment, a method for rendering a surface nonadhesive to insects is described. The method may include providing a surface, wherein the surface is desired to be nonadhesive to an insect having a foot contact structure, and applying to the surface a coating comprising particles, wherein the particles have an average dimension that is commensurate to a contact area size of the contact structure of the insect. The particles have, on average, a size in the range of 0.1 to 3.0 microns.

In the method of the second embodiment, the insect foot contact structure may include a plurality of setae and the particle average dimension is commensurate to a contact area size of a seta.

In the method of the second embodiment, the surface can be coated with polytetrafluoroethylene (or other polymers), plastic, glass, ceramic, or metal particles.

In the method of the second embodiment, the insect can be a stink bug. However, in other embodiments, the insect can be any arthropod and/or any flying/crawling insect.

In the method of the second embodiment, the surface can be inclined from horizontal, vertical, hemispherical, or horizontal facing toward the ground.

In a third embodiment, an insect nonadhesive surface is described. The insect nonadhesive surface may include an underlying substrate, and a coating comprising particles on a surface of the substrate, wherein the particles have an average dimension that is commensurate to a contact area size of a contact structure of the insect. The particles have, on average, a size in the range of 0.1 to 3.0 microns.

In the insect nonadhesive surface of the third embodiment, the surface can be coated with polytetrafluoroethylene, plastic, glass, ceramic, or metal particles.

In the insect nonadhesive surface of the third embodiment, the average particle dimension can be commensurate in size to the contact surface area of a seta on the foot of a stink bug.

In the insect nonadhesive surface of the third embodiment, the surface can be inclined from horizontal, vertical, hemispherical, or horizontal facing toward the ground.

In a fourth embodiment, an insect slippery surface is disclosed. The insect slippery surface includes surface features sized to be commensurate to a contact area size of a contact structure of an insect.

In the fourth embodiment, the surface features are voids, pores, holes, bumps, protrusions, indentations, ridges, grooves, and the like.

In the fourth embodiment, the surface features are applied to an underlying substrate by coating with an emulsion or film.

In the fourth embodiment, the surface features are applied by creating the surface features on a substrate, the surface features and the substrate being the same material.

A device configured to be used in an insect trap including a cone, funnel, or pyramid is also described. The device includes a central aperture configured to fit over a cone, funnel, or pyramid, a lower edge configured to extend from the cone, funnel, or pyramid, and a substrate extending between the central aperture and the lower edge, wherein a side of the substrate is covered with surface features, and wherein an average size of the surface features is commensurate in size to a size of an insect foot contact structure.

In one embodiment of a device, the average size of the surface features is from 0.1 to 3.0 microns.

In one embodiment of a device, the substrate is coated with a layer comprised of particles.

In one embodiment of a device, the particles are bonded to the substrate.

In one embodiment of a device, the particles are applied to the substrate and are retained on the substrate, such that the particles are released when stepped on by insects.

In one embodiment of a device, the substrate is coated with polytetrafluoroethylene particles.

In one embodiment of a device, a porous film comprising the surface features is placed over the substrate.

In one embodiment of a device, the substrate is a surface arranged to be at an incline from horizontal, vertical, hemispherical, or horizontal facing toward the ground.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a diagrammatical illustration of a device with a substrate having an insect nonadhesive surface;

FIG. 2 is a diagrammatical illustration of a device with a substrate having an insect nonadhesive surface;

FIG. 3 is a diagrammatical illustration of a device with a substrate having an insect nonadhesive surface;

FIG. 4 is a diagrammatical illustration of a substrate with surface features;

FIG. 5 is a diagrammatical illustration of a substrate with surface features;

FIG. 6 is a diagrammatical illustration of a substrate with surface features; and

FIG. 7 is a diagrammatical illustration of a trap that includes an embodiment of a nonadhesive device.

### DETAILED DESCRIPTION

There are many insect traps known to use funnel, pyramid or cone (inverted or not) structures as insect entrances. The funnel, pyramid or cone-shaped structures lead insects into the traps via a small opening or hole at the top (or tip) end of the cone or funnel structure. The purposes of these structures are to help lead insects into the trap, and prevent insects from finding their way out of the trap. However, if there are no toxic or sticky agents or water to kill the captured insects in the trap, the insects might be able to easily walk around inside the trap until they find their way out via the entrance hole(s) before the insect becomes dehydrated inside the trap. The escape rates for many insects and trap designs could reach as high as 50-70%. In order to reduce the escape rates and improve the trap efficacy (and also avoid using any toxic agents in the consumer market), a mechanism, device or structure to achieve these goals is strongly needed.

A method for reducing the ability of insects to adhere to a surface is disclosed. The method may be employed to create nonadhesive surfaces in proximity to trap openings to lessen the insect escape rate. The method includes providing a substrate, wherein a side of the substrate is covered with surface features, and wherein an average size of the surface features is commensurate in size to a size of an insect foot contact structure, and when insects walk or land on the substrate covered with the surface features, reducing the forces that bind the insect contact structures to the surface features by reducing the contact area between the insect contact structures and the surface features. The attachment or adhesion of insects to surfaces is reduced so that it becomes difficult for the insects to walk on the surfaces, thus making it harder for the insect to escape the trap.

The average size of the surface features can be from 0.1 to 3.0 microns and the size of the insect contact structures can be from 0.1 to 3.0 microns. In one embodiment, the size of the surface features can refer to an average diameter when the surface features are created using particles applied to a substrate. In one embodiment, the size of the surface features can refer to a pore diameter, such as when surface features are created through the application of a porous film to a substrate. In other embodiments, the size of the surface features can refer to an average dimension of any void, bump, protrusion on a surface of a substrate. When referring to insect contact structures, the size can refer to a diameter or a lateral width of the insect contact structure. The insect foot contact structure can include a plurality of setae and the surface features are commensurate in size to a diameter or lateral width of a seta. The insect foot contact structure can include a plurality of spatulae and the surface features are commensurate in size to a diameter or lateral width of a spatula.

To create the nonadhesive surface, the substrate can be coated with a layer comprised of particles. The particles can be bonded to the substrate, or the particles can be retained on the substrate, such that the particles are released when stepped on by insects. In one embodiment, the substrate can be coated with polytetrafluoroethylene particles.

The method may further include placing a porous film comprising the surface features over the substrate.

The substrate can be arranged to be at an incline from horizontal, vertical, hemispherical, or horizontal facing toward the ground. The nonadhesive surface can be placed inside of a trap and juxtaposed in proximity to an opening leading into the trap, such that the surface prevents insects from leaving the trap once inside the trap. A trap may include a chamber, one of a cone, funnel or pyramid, with an opening leading to an interior of the chamber, and the nonadhesive surface is juxtaposed in proximity to the opening on the inside of the chamber. A trap may also include a chamber, one of a cone, funnel, or pyramid, with an opening leading to an interior of the chamber, and the cone, funnel, or pyramid comprises the nonadhesive surface as compared to using a separate device with the nonadhesive surface.

Insects, as used herein, is meant to encompass any and all animals grouped in the classification class: Insecta or subphylum: Hexapoda or phylum: Arthropoda. The mentioning of any specific insect herein is only to illustrate certain specific embodiments. Any specific species belonging to the above-mentioned class(es) is a suitable target for the methods of preventing the insect from adhering to surfaces. In one specific embodiment, the insect can be a stink bug, such as the brown marmorated stink bug.

In one embodiment, the surfaces with the specific sized surface features can be utilized in insect traps. In one specific embodiment, an insect nonadhesive surface is disclosed that can be used in combination with any funnel or cone-shaped entrance or as part of an inverted cone or funnel entrance structure for efficiently avoiding the escape of the captured insects and for increasing the sliding effect for insects entering the trap. However, while the nonadhesive surface is disclosed for use in traps, the nonadhesive surface with specifically sized features disclosed herein may have applications in many other products.

In one embodiment, the disclosed insect nonadhesive surface includes any one of surface features, such as pores, voids, holes, bumps, protrusions, projections of any kind, channels, trenches, ridges, grooves, indentations of any kind, formed on, or otherwise provided on the surface. Surface features can be provided in a regular pattern or irregular pattern, the features can be rough or irregular, or may be smooth and continuous. Surface features can be rounded, curved, or have sharp edges. The surface features can be closely spaced or spread apart on the surface. In some embodiments, the surface features can be created by applying a material or coating that is different than the underlying substrate. Alternatively, in other embodiments, a substrate is treated or otherwise is processed to create the surface features from the underlying substrate. The substrate can be treated to create the surface features without the need for applying a coating or film. For example, the substrate can be etched with acids, reacted with air, such as the creation of oxides by heat treating, dissolved by a strong solvent, or etched with mechanical tools, and including laser etching. In some embodiments, the coating or film providing the surface features can be applied as a solid or liquid to the underlying substrate. Before applying the coating or film to the substrate, the substrate can be prepared to receive the coating or film, such as by cleaning or roughing, or applying a first coating or film to enhance the bonding of the slippery coating or film that creates the surface features. A characteristic is that the surface features to be nonadhesive are commensurate in size with the contact area of a contact structure of an insect's foot.

The bottom of insect feet can include intricate contact structures that include a plurality of micro-sized setae (singular: seta) or hairs on the bottom of insect feet. In some insects, the individual setae may further comprise many smaller contact structures called spatulae (singular: spatula). The setae or hairs or spatulae on the bottom of insect feet contact surfaces provide the insect with the ability to hold on to the surface. It is believed that some setae, hairs, or spatulae on the bottom of insect feet are attracted to surfaces via intermolecular forces. It is through or because of these attractant forces created by setae and spatulae that insects can adhere to inclined, vertical or upside down surfaces.

In accordance with one aspect of the invention, it is believed that providing surface features that are commensurate in sizes such as being approximately equal to a lateral dimension of the setae/hair or spatulae will contribute to loss of adhesion of the contact structure. The attractant forces are reduced, and adhesion is lessened. The lateral dimension may refer to a diameter of the setae/hair or spatulae. In other instances, the lateral dimension may refer to a width across the setae/hair or spatulae when the setae/hair or spatulae is in contact with a surface.

The contact structure lateral dimension can range from fractions of nanometers to several micrometers in size. Accordingly, in some embodiments, the surface features can have dimensions ranging from fractions of a nanometer to several micrometers Surface features provided in the manner described herein have the effect of lessening the ability of the insect contact structure to adhere to the surface. As used herein, a “nonadhesive” surface refers to a surface having surface features sized in the manner described herein that reduces, partially or completely, the attraction and/or adhesion forces that bind the insect's contact structure to the surface, compared to an otherwise similar surface without the surface features. The insect nonadhesive surface may be totally or partially nonadhesive depending on the particular type of insect or the specific foot contact structure of the insect.

In some embodiments, a device having a nonadhesive surface can be incorporated into insect traps to improve the ability of the trap to contain the insects once inside the trap.

In some embodiments, the device can be provided with a curved nonadhesive surface (smooth or fine-textured) that can be snapped on or attached to the inverted funnel or cone entrance. The device is provided with the nonadhesive surface with the sized surface features described herein.

In some embodiments, the nonadhesive effect can be created by coating any device, structure, or surface, with synthetic materials such as fine polymer particles (powder) having average sizes of approximately 0.1-3.0 μm. For example, a nonadhesive layer on the device may be created using polytetrafluoroethylene powder such as that marketed under the trade name Teflon® or Fluon®. In some embodiments, the surface features can be applied to any device, structure, or surface by dipping, spraying or direct attachment in the case of porous films.

In some embodiments, films having the right sized pores and density can be applied over a substrate. Suitable pore sizes to create nonadhesion are approximately 0.1-3 μm, and the films have a porosity (void fraction) of 20-50% of the total area of the surface. Films made from aluminum oxide or any other organic or inorganic materials having the pore sizes and porosity within the nonadhesive ranges may be used.

In other embodiments, the device substrate itself may be treated to have surface features of approximately 0.1-3.0 μm in size. For comparison, a house fly can have contact structures of about 2 μm. Treatments may include etching, for example, by acids or lasers, sanding, and the like.

In some embodiments, devices may utilize straight planes and curves, or any combination to prevent insects from crawling their way out of traps. In one embodiment, the structure can be shaped to encourage insects to walk from the top first, which is horizontally disposed, but then the surface drops steeply as the insect approaches the outer edge.

In some embodiments, part(s) of a cone, pyramid, or funnel-shaped entrance structure of traps can also be treated in a similar fashion to create the nonadhesive surfaces (without a separate device or structure performing this function). The cone, pyramid, and funnel-shaped entrance structures can be solid (i.e., without holes), since solid surfaces are easier to treat with slippery agents. A slippery effect, for instance, may be desired on the surfaces encountered by the insect as soon as the insect enters the opening to the trap and is inside the trap. In traps with cones and funnels, this may be at the top juxtaposed in proximity to an opening into the trap. It is preferable to apply the agents on the top without contaminating the climbing surfaces designed to lead the insect into the trap.

The nonadhesive surfaces and structures disclosed herein are effective against many flying, crawling, walking, or climbing insects (arthropods) (including the stink bugs, bed bugs, beetles, etc.) at most stage of development including the larvae/nymph stage to the adult stage.

The nonadhesive surface substrates, structures, devices, and methods disclosed herein can be used on any funnel, pyramid, and cone-shaped trap entrances to increase trap performance by decreasing insect escape rates.

In some embodiments, the surface features have a size that is generally in the range of 0.1 microns to 3.0 microns. In some embodiments, the surface features are created on an underlying substrate through the application of an aqueous dispersion of particles having such size range. It is to be appreciated that voids or spaces of approximately the same size are created in the interstices between particles. Voids and spaces are also considered surface features.

It is believed that surfaces having surface features, such as pores, voids, bumps, or other surface features of any kind within a size range that corresponds to the size of contact structures on insect feet prevent the insect feet from adhering to such surfaces by reducing forces between the insect contact structures and the surface features. The contact area between the insect feet contact structure to the surface is minimized by the creation of surface features, such as but not including, voids, pores, and bumps, in the surface, such that the area of contact between the insect feet contact structures and the surface is reduced. Additionally, if the surface features are commensurate with or approximately the same size as the insect feet contact structures, the contact structures intermittently make contact with the surface features, such that the contact structures on the insect feet have little contact with solid surfaces.

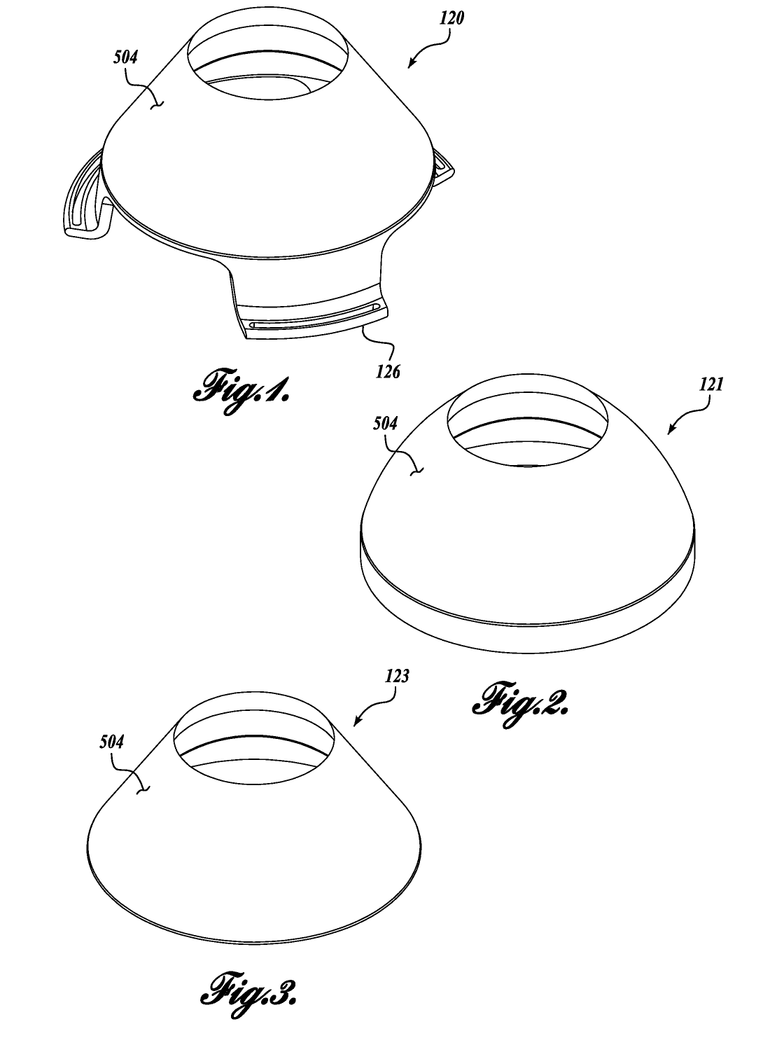

In FIGS. 1, 2 and 3, three devices such as collars 120, 121, and 123 suitable to be used with a funnel, pyramid or cone entry structure for an insect trap, are shown with a surface 504 provided with surface features that reduce the insect's ability to adhere to the surface 504. It is believed that the insect nonadhesive surface 504 of the collars 120, 121, and 123 reduces the forces that create adhesion by reducing the contact area between the surface 504 and the insect's contact structures, thus reducing the insect's ability to adhere to the surface 504.

Referring to FIG. 4, which is a highly diagrammatical illustration, the nonadhesive surface 504 is illustrated comprising a substrate 510 and a coating or layer 506 of particles, which creates the nonadhesive surface. The average size (diameter) of the particles can be in the range of 0.1-3.0 μm. It is to be appreciated that the interstices between particles can also be in the range of 0.1-3.0 μm. In the illustrated embodiment, the surface 504 is made from particles that create a surface with closely spaced surface features and interstices, such that the insect feet contact structures 502, such as setae or spatulae, either fall into the interstices created between the particles losing contact with a solid surface, or the insect feet contact structures 502 are only minimally supported by very reduced surface area to surface area contact. The surface features 506 including the particle and interstice sizes are commensurate in size to the insect feet contact structures 502. Thus, if the particles and interstices are in the size of 0.1-3.0 μm, then, the lateral size or width of the insect contact structures 502 is 0.1-3.0 μm.

In the illustrated embodiment of FIG. 4, the coating or layer 506 may be created by preparing an aqueous dispersion of synthetic particles, such as polytetrafluoroethylene powder particles having, on average, a dimension in the range from 0.1 to 3 microns. To the aqueous dispersion is added a surfactant. Surfactants, for example, may include an ethylene oxide/propylene oxide copolymer such as that marketed under the trade name Tergitol®. The surfactant acts to disperse the polytetrafluoroethylene powder particles uniformly throughout the water and create an emulsion through shaking or vigorous mixing. In the emulsion, the polytetrafluoroethylene powder is approximately 30-60% by weight, the surfactant is approximately 5% by weight, both based on the total weight of the emulsion. The substrate 510 can then be sprayed or immersed in the emulsion or the coating can be created by brushing the emulsion directly to the substrate 510. The substrate 510 may already have a surface texture or roughness that allows the polytetrafluoroethylene (or other material) particles to be embedded within the crevices and imperfections on the surface. Additionally, the substrate 510 may be pretreated by first applying a primer to cause greater adhesion or may be roughened by sanding or otherwise to create greater embedment of the particles to the substrate 510. Synthetic particles for the substrate 510 can include, but are not limited to, plastics, metals, and ceramics. Additionally, the substrate 510 may have micro or macro sized features on the surface prior to the application of the coating 506. These features are separate and distinct from the features created by the application of the coating 506. The features inherent in the surface of the substrate 510 may further enhance bonding of the coating to the substrate 510. These secondary surface features may include any kind of indentation, such as grooves, chevrons, slits, slots, bumps, spheres, blocks, wavy contours, and the like. Additionally, the inherent surface features of the substrate 510 may also contribute to lose of adhesion for insect contact structures.

After application, the emulsion may be allowed to dry at room temperature or the substrate 510 can be placed in an oven to speed the drying process. However, the drying temperature should not exceed the softening temperature of the substrate 510 material. A second or multiple coatings of the emulsion can be applied when the first coating has dried. The coating can be built up to a thickness, such that the coating may last for the anticipated life of the trap. By applying multiple coatings, the life of the nonadhesive surface may be extended.

In another embodiment, strong bonding of the particles to the underlying substrate may be decreased. In this case, the particles are only loosely attached to the surface. Insects known to secret adhesive compounds will secret the compounds onto the loose particles and thereby cause such particles to become adhered to the insect feet. The loss of particles from the surface also means that the insect loses adhesion to the underlying substrate, thereby providing an alternative form of nonadhesive surface.

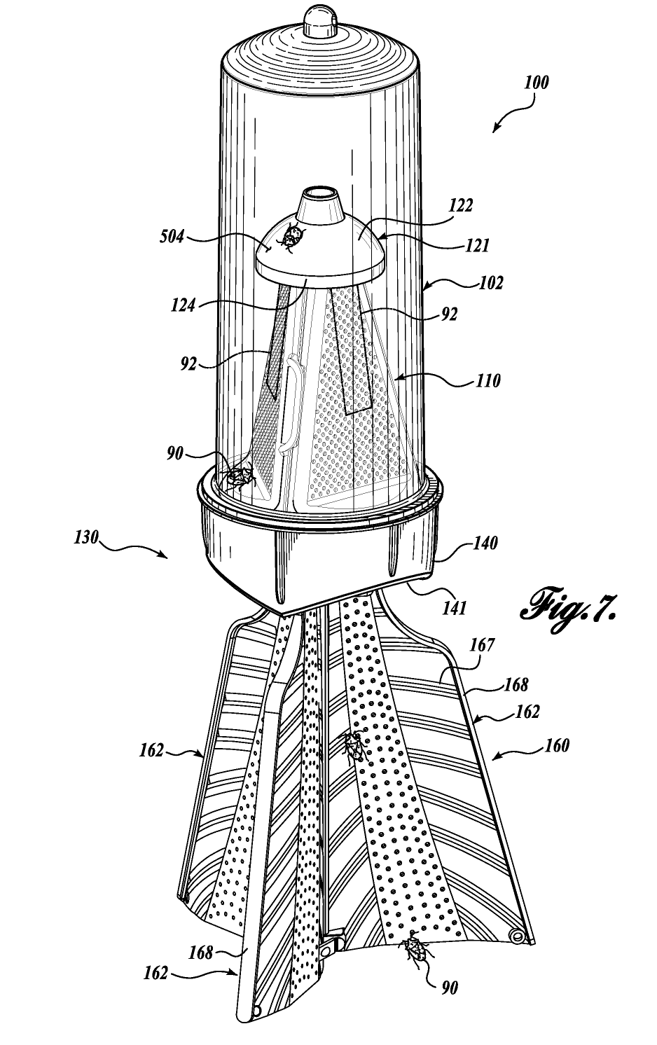

In another embodiment shown in the highly diagrammatical illustration of FIG. 5, a film 508 having features (e.g., pores) 514 in the sizes specified herein of from 0.1-3.0 μm, may be joined to the underlying substrate 510 as a way to provide the nonadhesive surface 504. The surface features 514 of the film 508 including the pores and the bridges between pores are commensurate in size to the insect feet contact structures 502. Thus, if the pores and bridging structures are in the size of 0.1-3.0 μm, then, the lateral size or width of the insect contact structures 502 is 0.1-3.0 μm. The film 508 may be made from oxides, plastics, synthetic materials, and the like.

In another embodiment shown in the highly diagrammatical illustration of FIG. 6, a nonadhesive surface 504 with surface features 512 is created from the substrate 510 itself to provide the nonadhesive surface 504. The substrate 510 may be etched, such as with acids or a laser to provide the substrate 510 with features 512 having a size of 0.1-3.0 μm. The features 512 including the crevices and areas left unetched are commensurate in size to the insect feet contact structures 502. Thus, if the crevices and areas left unetched have a size of 0.1-3.0 μm, then the lateral size or width of the insect contact structures 502 is 0.1-3.0 μm.

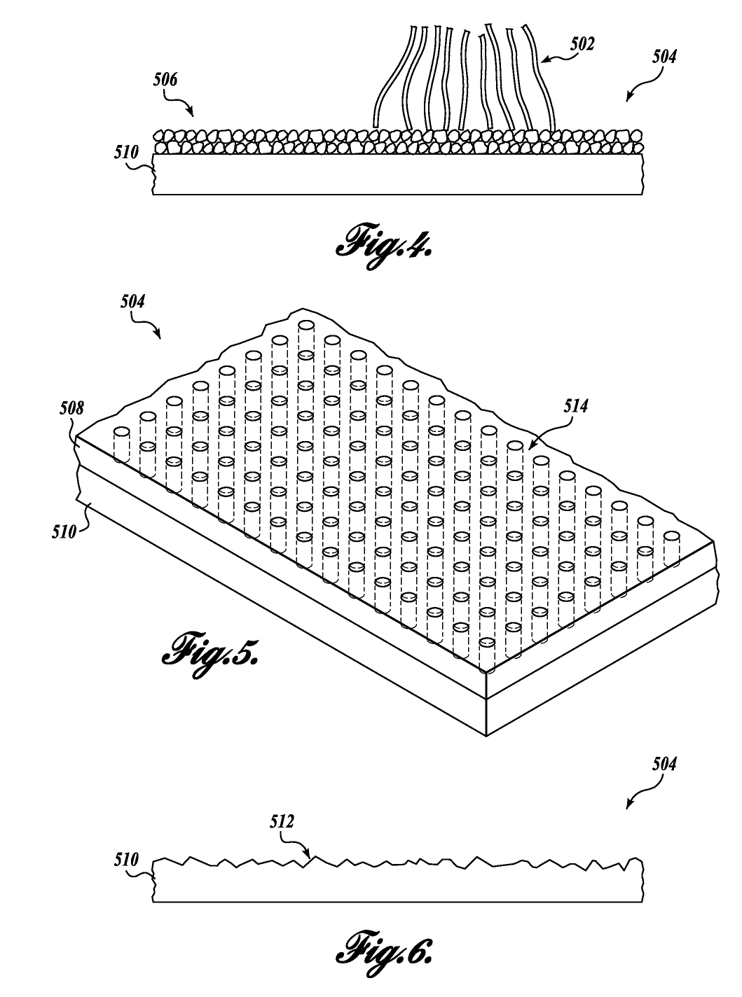

To further prevent insects from climbing on or adhering to the surface 504 of devices 120, 121 and 123, the top surface may be inclined with respect to a plane horizontal to the ground surface. In the frustoconically-shaped devices 120 and 123 of FIGS. 1 and 3, the surface 504 may be inclined 30 or more degrees from horizontal, and may include a vertical surface as well. However, an angle less than 30 degrees may still be used. Typical angles of inclination from horizontal include, but are not limited to, 30, 45, 50, 60, and 75 degrees. In the hemispherically-shaped device 121 of FIG. 2, the surface angle with respect to horizontal is continuously changing due to the hemispherical nature and begins at or near vertical at the lower edge of the collar 121 to at or near horizontal at the very top of the collar 121. This has an advantage that encourages insects to walk horizontally, and then fall on the steeply inclined part. While a hemispherical surface is illustrated as one curved embodiment, other curved surfaces having angles at or between 90 to 0 degrees with respect to horizontal may be used. In another embodiment, it is possible that the surface is horizontal, such as when the horizontal surface is a surface facing the ground. This can be visualized by considering a fly on the ceiling. Accordingly, the present method of preventing insects from adhering to surfaces also includes those surfaces that are horizontal surfaces facing toward the ground/floor.

The devices 120, 121, and 123 of FIGS. 1, 2, and 3 have a central aperture at the apex or top of the device. The central aperture may fit over the top of any entry cone, pyramid, or funnel used in an insect trap, such that the device 120, 121, or 123 will be supported by the central aperture resting against the sides of the cone, pyramid, or funnel. In one embodiment, the central aperture has a spherical shape; however, the central aperture can be changed to match the shape of the cone, pyramid, or funnel. The devices 120, 121, and 123 have a lower edge. The perimeter of the lower edge may also have a spherical shape. The substrate provided between the lower edge and the central aperture allows for placement of the insect nonadhesive surfaces 504 described above. Specifically, the upper side of the substrate is provided with the nonadhesive surface 504. Also, the diameter defined by the lower edge of the devices 120, 121, and 123 is larger than the diameter defined by the central aperture, such that when the device is placed over the top of the cone, pyramid, or funnel of the insect trap, the lower edge of the devices 120, 121, and 123 extends away from the side surfaces of the cone, pyramid or funnel. This provides an overhang that increases the difficulty for insects to traverse across should the insects climb on the outside of the cone, pyramid, or funnel in an attempt to escape the trap. Furthermore, the height between the lower edge and the central aperture as well as the diameter of the lower edge influence the angle of sloping between the central aperture and the lower edge. The device 120 includes a plurality of hooks 126, the purpose of which is to hang an insect attractant, for example.

While one embodiment is described using polytetrafluoroethylene powder particles, other particles or other materials in a variety of combinations might be used having a smooth or slippery surface. However, as mentioned above, particles are not necessary to create a surface having features that deter insects from adhering. As discussed above, the surface with particular sized surface features can be created in a multiplicity of ways. Furthermore, while polytetrafluoroethylene is known for its nonadhesive and slippery properties, these properties are believed not to be fully responsible or at all responsible for the insect nonadhesiveness properties of the disclosed coatings and surfaces. Therefore, other materials, such as, but not limited to, any polymer or plastic, microspheres of glass, ceramics, or metal oxides, for example, may also be used in the coatings to create an insect nonadhesive surface. These other materials may similarly be provided in a size range that corresponds to the size of contact structures of insects. For example, in the size of approximately 0.1 to 3.0 μm.

Accordingly, the various insect nonadhesive surfaces and coatings described herein may be used as means for deterring or preventing insects from climbing on or occupying an area. The surfaces and coatings described herein may be used for deterring insects from walking or crawling onto any protected area. While one embodiment of an insect nonadhesive surface is provided within an insect trap, the surfaces and coatings described herein may be applied to other structures, for example, on kitchen walls, appliances, or other food storage or preparation areas for the prevention of insects crawling on, landing on, or walking over these areas.

Another embodiment is therefore a method for preventing or deterring insects from areas. The method can reduce the ability of insects to adhere to a surface. The method may further provide a surface desired to be free of insects, such as any inclined surface with respect to horizontal, or otherwise, wherein the surface includes surface features, including, but not limited to pores, voids, bumps, ridges, grooves, protrusions, indentations of any kind, wherein the contact area of an insect contact structure on the bottom of insect feet is commensurate with the size of the surface features on such surface. The surface features can be closely packed next to each other on the surface, and also provide interstices. In one embodiment, these surface features are created through coatings with particles having dimensions (such as average diameter) commensurate in size to the diameter, width, or lateral dimension of the setae or hair or spatulae on the bottom of the feet of the targeted insect. However, other means of achieving the surface features of particular size are also disclosed herein.

FIG. 7 is a perspective view of an insect trap 100 suited for capturing insects such as stink bugs 90, for example, the brown marmorated stink bug. The insect trap 100 is a representative example where the nonadhesive surface 504 described herein may be used by incorporating a device having a substrate provided with the nonadhesive surface 504. The trap 100 is described in applicants' U.S. Provisional Application No. 61/435,647, filed on Jan. 24, 2011, and U.S. application Ser. No. 13/331,394, filed on Dec. 20, 2011, both incorporated herein expressly by reference.

The trap 100 comprises an upper entrapment chamber 102, which in this embodiment is a generally cylindrical member that is open at the bottom end and closed at the top end. An inner member herein referred to as the cone 110 is disposed in the entrapment chamber 102. The cone 110 tapers from a large opening at the bottom end disposed near the entrapment chamber bottom end to a small opening 112 at the top end disposed inside the entrapment chamber 102. The collar 121 of FIG. 2 fits over the top end of the cone 110. The collar 121 in this embodiment is a hemispherically shaped portion with a hole that fits snugly over the tip and rests against the sides of the cone 110 and a lower edge 124 that extends away from the cone 110. Preferably, the surface of the hemispherical upper portion is provided with the nonadhesive surface 504 as described herein, to facilitate the target insects 90 falling to the bottom of the entrapment chamber 102, and to prevent insects 90 from crawling back out of the trap 100 through the cone opening 112.

A lower base portion 130 of the trap 100 may include an annular lid 140 that is releasably attached to the entrapment chamber 102, and a vane assembly 160 assembled from a plurality of panels or vanes 162 (three shown) extend downwardly from the annular lid 140.

The base may be supported by the plurality of vanes 162. In the present embodiment, the vanes 162 are designed with particular features that also take advantage of the stink bug's 90 behavioral tendencies. Stink bugs 90, for example, tend to alight on a surface, such as the ground, and to climb. For example, they may approach and even strike a vane 162 causing them to land at the base of the vane 162. The vanes 162 are designed to encourage the insect 90 to climb the vane 162 and to enter the entrapment chamber 102 through the bottom thereof. The vanes 162 are each curved in horizontal cross section to provide a more natural and organic shape that will be more inviting to the insect 90. For example, the vanes 162 may be provided with surface features that encourage and facilitate climbing. For example, center portions of the vanes 162 may be provided with a plurality of apertures. The apertures facilitate climbing by providing a perch for the insects 90, and also permit air and light to penetrate, again providing a more organic-mimicking environment to encourage continued climbing. The vanes 162 may further include a plurality of surface ridges 167. The ridges 167 generally mimic a leaf vein structure and further facilitate climbing the vane 162. The outer edge of each vane 162 is further provided with a flange 168 set perpendicular to the vane 162, such that climbing insects 90 are directed upwardly when they reach the flange 168.

One or more sources of an insect attractant 92 are enclosed within the entrapment chamber 102. The insect attractant 92 can be provided in packages that allow the chemical attractant to diffuse through the package materials. The attractant, e.g., a pheromone attractant, disposed in the trap is preferably packaged, formulated, or otherwise adapted to release gradually over time. The concentration of attractant will naturally rise within the entrapment chamber 102, and escape the trap 100 to generate a plume. The plume will in general increase in concentration as it is followed towards the trap 100. In particular, the attractant concentration will generally be greatest in and around the trap 100. Target insects will therefore be attracted first to the general vicinity of the trap 100 by the external plume. The typical, instinctual behavior of the stink bugs, such as the brown marmorated stink bug, is to land near or on a vertical structure and to climb upwardly. In the present trap 100, stink bugs landing near or on the vanes 162, drawn by the attractant plume, will sense an organically configured surface defined by the shape of the vanes 162, and will be motivated to climb the vanes 162 by the increasing concentration of attractant as the insect moves nearer to entryways provided at the bottom 141 of the lid 140. From the lid 140, the insects pass into the bottom of the cone 110 and continue climbing upwards and in the interior of the cone 110. Upon reaching the opening 112 at the top of the cone 110 (toward a relatively open space beyond), the insects proceed, but the relatively steep angle and smooth surface of the cone 110 and the nonadhesive surface 504 of the collar 121 cause the insect to slide or fall down to the base of the cone 110. Moreover, the collar 121 effectively prevents trapped stink bugs from escaping the entrapment chamber 110 through the opening 112.

As described above in relation to FIG. 4, the collar 121 upper portion 122 may include a layer 506 of synthetic materials, such as polytetrafluoroethylene powder (e.g., with a particle size of 0.1 to 3.0 microns), such as that marketed under the trade names Teflon® or Fluon®. In an exemplary treatment, the polytetrafluoroethylene powder layer is achieved by applying (e.g., dipping or spraying) to the upper portion 122 an aqueous solution of polytetrafluoroethylene powder and a surfactant, for example, an ethylene oxide/propylene oxide copolymer such as that marketed under the trade name Tergitol®.

Additionally or alternatively, the collar 121 upper portion may also include a layer of porous film 508 as described in relation to FIG. 5. For example, a film having a pore size of 0.1-3.0 microns and a porosity (void fraction) of 20-50% of the total area of the film may be attached to the upper surface 122. Such film can be made from aluminum oxide or any other organic or inorganic material that could create the pore sizes and porosity in the above-referenced ranges. Furthermore, the whole collar 121 may be made from a porous material (e.g., with pore sizes and porosities in the nonadhesive range) that is strong enough to withstand the insect activities.

Alternatively, the collar 121 substrate may also be treated to create rough surface features 512 of approximately 0.1-3 μm, as described in relation to FIG. 6.

It will be appreciated that in the trap 100 shown in FIG. 7, the collar 121 (of FIG. 2) may be substituted with either the collar 120 or 123 shown in FIGS. 1 and 3, respectively. Although similar in function to the previously described collar 121, in the embodiments of FIGS. 1 and 3, the collars 120 and 123 are generally frustoconical in shape, with a center aperture provided to fit snugly over the cone 110, and a lower edge that extends away from the cone's surface. The upper surface 504 is similarly designed to be nonadhesive to the insect 90 and may include any one of the nonadhesive surfaces 504 shown in FIG. 4, 5, or 6. The collar 121 is preferably provided with surface features also at least covering the upper surface of the collar 121 that are sized to approximately correspond to the size of the target insect's contact structures, e.g., 0.1-3.0 microns. The hemispherical shape of the collar 121 makes it easier for the insect 90 to move from the cone 110 to the collar 121. A hemispherical surface provides a relatively horizontal surface where it interfaces with the cone and increasingly becomes more steep as the insects 90 travel further out. Easier access to the collar 121 may ease congestion at the collar 121 by inducing insects 90 to step onto and continue crawling.

Additionally or alternatively, instead of providing a collar, such as collar 120, 121 or 123, the cone 110 may be provided with a nonadhesive surface 504 with sized surface features as described herein to render any parts of the cone 110 nonadhesive to insects. Further, while embodiments of the invention are described with reference to devices, such as collars 120, 121, and 123, and traps, it is to be appreciated that the devices and methods disclosed herein may be used on or for any surface or substrate and are not limited to collars and insect traps. Reference to the trap 100 of FIG. 7 and to the collars 120, 121, and 123 is merely for the purpose of illustrating embodiments of the invention. Collars 120, 121, and 123 are representative of devices where an insect nonadhesive surface 504 would be desirable.

A method for reducing the ability of insects to adhere to a surface includes providing a substrate 510, wherein a side of the substrate 510 is covered with surface features 506, 508, or 512, and wherein an average size of the surface features is commensurate in size to a size of an insect foot contact structure 502, and when insects walk or land on the substrate covered with the surface features, reducing the forces that bind the insect contact structures to the surface features by reducing the contact area between the insect contact structures and the surface features. In one embodiment of the method disclosed herein, a nonadhesive surface 504 can be arranged to be at an incline from horizontal, vertical, hemispherical, or horizontal facing toward the ground, such as on the collars 120, 121 or 123. In one embodiment, a nonadhesive surface 504 can be placed inside of the trap 100 and juxtaposed in proximity to an opening 112 leading into the trap, and the surface 504 prevents insects from leaving the trap once inside the trap. In one embodiment, the trap 100 may include a chamber 102, one of a cone, funnel or pyramid 110, with an opening 112 leading to an interior of the chamber 102, and the nonadhesive surface 504 is juxtaposed in proximity to the opening on the inside of the chamber. In one embodiment, the trap 100 may include a chamber, one of a cone, funnel, or pyramid, 110, with an opening 112 leading to an interior of the chamber, and the cone, funnel, or pyramid 110, comprises the nonadhesive surface 504.

While the preferred embodiment of the invention has been illustrated and described, it will be appreciated that various changes can be made therein without departing from the spirit and scope of the invention. For example, sizes of the surface features have been described being within the range of 0.1-3.0 microns. The surface features can also be within the range of 0.1-5.0 microns. Of course, the surface features may have an average or median size anywhere in these ranges, such as, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0 microns. A method of determining an appropriate size of the surface features may be to measure the lateral width of an insect's contact structure when in contact with a surface (such as via transmission X-ray microscopy), and creating the surface features to be anywhere between 0.1 to 10 times the measured width. In some embodiments, the surface features can be between 0.5 to 2 times the measured width of the insect contact structure. In some embodiments, the surface features can be between 0.8 to 1.5 times the measured width of the insect contact structure.

The embodiments of the invention in which an exclusive property or privilege is claimed are defined as follows:

1. A method for reducing the ability of insects to adhere to a surface, comprising:
providing a substrate, wherein a side of the substrate is covered with surface features, and wherein an average size of the surface features is commensurate in size to a size of an insect foot contact structure; and
when insects walk or land on the substrate covered with the surface features, reducing the forces which bind the insect contact structures to the surface features by reducing the contact area between the insect contact structures and the surface features.

2. The method of claim 1, wherein the average size of the surface features is from 0.1 to 3.0 microns and the size of the insect contact structures is from 0.1 to 3.0 microns.

3. The method of claim 1, wherein the insect foot contact structure includes a plurality of setae and the surface features are commensurate in size to a diameter or lateral width of a seta.

4. The method of claim 1, wherein the insect foot contact structure includes a plurality of spatulae and the surface features are commensurate in size to a diameter or lateral width of a spatula.

5. The method of claim 1, wherein the substrate is coated with a layer comprised of particles.

6. The method of claim 5, wherein the particles are bonded to the substrate.

7. The method of claim 5, wherein the particles are applied to the substrate and are retained on the substrate, such that the particles are released when stepped on by insects.

8. The method of claim 1, wherein the substrate is coated with polytetrafluoroethylene particles.

9. The method of claim 1, further comprising placing a porous film comprising the surface features over the substrate.

10. The method of claim 1, wherein the insect is a stink bug.

11. The method of claim 1, wherein the substrate is arranged to be at an incline from horizontal, vertical, hemispherical, or horizontal facing toward the ground.

12. The method of claim 1, wherein the substrate is placed inside of a trap and is juxtaposed in proximity to an opening leading into the trap, and the surface features prevent insects from leaving the trap once inside the trap.

13. The method of claim 12, wherein the trap comprises a chamber, one of a cone, funnel or pyramid, with an opening leading to an interior of the chamber, and the substrate is juxtaposed in proximity to the opening on the inside of the chamber.

14. The method of claim 12, wherein the trap comprises a chamber, one of a cone, funnel, or pyramid, with an opening leading to an interior of the chamber, and the cone, funnel, or pyramid comprises the substrate.

15. The method of claim 1, wherein the substrate is on a device having a central aperture configured to fit over a cone, funnel, or pyramid, a lower edge configured to extend from the cone, funnel, or pyramid, and the substrate extends between the central aperture and the lower edge.

16. A device configured to be used in an insect trap comprising a cone, funnel, or pyramid, the device comprising:
a central aperture configured to fit over a cone, funnel, or pyramid;
a lower edge configured to extend from the cone, funnel, or pyramid; and
a substrate extending between the central aperture and the lower edge, wherein a side of the substrate is covered with surface features, and wherein an average size of the surface features is commensurate in size to a size of an insect foot contact structure.

17. The device of claim 16, wherein the average size of the surface features is from 0.1 to 3.0 microns.

18. The device of claim 16, wherein the substrate is coated with a layer comprised of particles.

19. The device of claim 18, wherein the particles are bonded to the substrate.

20. The device of claim 18, wherein the particles are applied to the substrate and are retained on the substrate, such that the particles are released when stepped on by insects.

21. The device of claim 16, wherein the substrate is coated with polytetrafluoroethylene particles.

22. The device of claim 16, further comprising placing a porous film comprising the surface features over the substrate.

23. The device of claim 16, wherein the substrate is a surface arranged to be at an incline from horizontal, vertical, hemispherical, or horizontal facing toward the ground.
